(19) United States
(12) Patent Application Publication
(10) Pub. No.: US 2009/0123609 A1
(43) Pub. Date: May 14, 2009

(54) METHODS OF PREPARING A LIQUID SUSPENSION FOR USE WITH ANIMAL FEED

(76) Inventors: Joseph M. Harris, Montgomery, TX (US); Paul Mostyn, Magnolia, TX (US)

Correspondence Address: BOOTH ALBANESI SCHROEDER LLC, 1601 ELM STREET, SUITE 1950, DALLAS, TX, 75201-4744, US

(21) Appl. No.: 11/937,455

(22) Filed: Nov. 8, 2007

(51) Int. Cl. A23K 1/00; A23K 1/06; A23K 1/16; A23K 1/175; A23K 1/22

(52) U.S. Cl. 426/69; 426/648; 426/573; 426/602; 426/635; 426/624; 426/330

(57) ABSTRACT

Methods of preparing a liquid suspension are provided. According to one aspect, the method includes mixing, simultaneously or in separate steps, at least: (a) a liquid source of digestible organic matter, wherein the liquid source of digestible organic matter includes: (i) water in a concentration of at least 25% by weight of the liquid source of digestible organic matter; and (ii) digestible organic matter in a concentration of at least 5% by weight of the liquid source of digestible organic matter, wherein the digestible organic matter comprises starch in a concentration of at least 10% by weight on a dry-matter basis. The liquid source of digestible organic matter is mixed with: (b) an alkali or alkali source and/or (c) a water-insoluble material selected from the group consisting of a nutrient, a medicament, and any combination thereof in any proportion. The mixing proportions and conditions are selected to obtain a resulting mixture have desirable dry-matter content and physical characteristics.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO A MICROFICHE APPENDIX

Not applicable

### TECHNICAL FIELD

The present invention generally relates to methods of preparing liquid suspensions for use with animal feed.

### SUMMARY OF THE INVENTION

According to one aspect of the invention, a method of preparing a liquid suspension is provided. According to this aspect, the method comprises mixing, simultaneously or in separate steps, at least: (a) a liquid source of digestible organic matter, wherein the liquid source of digestible organic matter comprises: (i) water in a concentration of at least 25% by weight of the liquid source of digestible organic matter; and (ii) digestible organic matter in a concentration of at least 5% by weight of the liquid source of digestible organic matter, wherein the digestible organic matter comprises starch in a concentration of at least 10% by weight on a dry-matter basis; and (b) at least a sufficient proportion of an alkali or alkali source to increase the stirred viscosity of the liquid source of digestible organic matter; and (c) a water-insoluble material selected from the group consisting of a nutrient, a medicament, and any combination thereof in any proportion.

According to another aspect of the invention, a method of preparing a liquid suspension comprising a water-insoluble carbonate is provided. According to this aspect, the method comprises mixing, simultaneously or in separate steps, at least: (a) a liquid source of digestible organic matter, wherein the liquid source of digestible organic matter comprises: (i) water in a concentration of at least 25% by weight of the liquid source of digestible organic matter; and (ii) digestible organic matter in a concentration of at least 5% by weight of the liquid source of digestible organic matter, wherein the digestible organic matter comprises crude fat in a concentration of at least 4% by weight on a dry-matter basis, wherein the liquid source of digestible organic matter has a stirred viscosity of at least 600 cP at a temperature between 68° F. (20° C.) and 80° F. (27° C.) and at a pressure of about 1 atm (100 kPa), and wherein the liquid source of digestible organic matter has a pH of less than 5.8; and (b) at least a sufficient proportion of a pH increasing agent to increase the pH of the liquid source of digestible organic matter to greater than or equal to 5.8; and (c) a water-insoluble material, wherein the water-insoluble material comprises carbonate selected from the group consisting of calcium carbonate (e.g., limestone) magnesium carbonate, and any combination thereof in any proportion.

According to another aspect of the invention, a further method of preparing a liquid suspension is provided. According to this aspect, the method comprises the steps of: (a) mixing: (i) a liquid source of digestible organic matter, wherein the liquid source of digestible organic matter comprises condensed distillers solubles having starch in a concentration of at least 10% by weight on a dry-matter basis and crude fat in a concentration of at least 4% by weight on a dry-matter basis, wherein the liquid source of digestible organic matter has a stirred viscosity of at least 600 cP at a temperature between 68° F. (20° C.) and 80° F. (27° C.) and at a pressure of about 1 atm (100 kPa), and wherein the liquid source of digestible organic matter has a pH of less than 5.8; (ii) at least a sufficient proportion of a pH increasing agent to increase the pH of the liquid source of digestible organic matter to greater than or equal to 5.8, wherein the pH increasing agent comprises an alkali or alkali source selected from the group consisting of calcium hydroxide, magnesium hydroxide, sodium hydroxide, potassium hydroxide, calcium oxide, magnesium oxide, and any combination thereof in any proportion; and (b) thereafter, mixing with the condensed distillers solubles a water-insoluble material, wherein the water-insoluble material comprises carbonate selected from the group consisting of calcium carbonate, magnesium carbonate, and any combination thereof in any proportion.

According to yet another aspect of the invention, a method of preparing a liquid suspension is provided, where the method comprises the step of mixing at least: (a) a liquid source of digestible organic matter, wherein the liquid source of digestible organic matter comprises: (i) water in a concentration of at least 25% by weight of the liquid source of digestible organic matter; and (ii) digestible organic matter in a concentration of at least 5% by weight of the liquid source of digestible organic matter, and (iii) starch in a concentration of at least 10% by weight on a dry-matter basis, and wherein the liquid source of digestible organic matter has a stirred viscosity of at least 600 cP at a temperature between 68° F. (20° C.) and 80° F. (27° C.) and at a pressure of about 1 atm (100 kPa); (b) a water-soluble nutrient; and (c) a water-insoluble material, wherein the water-insoluble material comprises carbonate selected from the group consisting of calcium carbonate, magnesium carbonate, and any combination thereof in any proportion. The mixing proportions are such that the resulting mixture has a dry-matter concentration in the range of 50%-70% by weight and a stirred viscosity of between 600-4,000 cP when measured at a temperature in the range of 68° F. (20° C.)-80° F. (27° C.) and about 1 atmosphere (100 kPa) pressure.

These and further aspects and advantages of the invention will become apparent to persons skilled in the art from the following detailed description of presently most-preferred embodiments of the invention.

### BRIEF DESCRIPTION OF THE DRAWING

The accompanying drawing is incorporated into and forms a part of the specification to illustrate aspects and examples of the present invention. The figure together with the description serves to explain the general principles of the invention. The figures is only for the purpose of illustrating preferred and alternative examples of how the various aspects of the invention can be made and used and is not to be construed as limiting the invention to only the illustrated and described examples.

FIG. 1 is a graph of the data in showing the suspension stability of the sample 0.83 Ca(OH)2/High Ca/High Urea based on calcium content % (side axis) vs. day sampled (lower axis) for the bottom, middle, and top positions.

### DETAILED DESCRIPTION

Conventional suspension supplements were designed to provide significant protein (primarily from urea) and phosphorus from ammonium poly-phosphate, as well as calcium, trace minerals, vitamins and other feed additives to meet animal requirements. Suspending aids—typically attapulgite clay or various thickening gums—were included to provide positional stability to the insoluble limestone used to supplement calcium. Use of phosphate was required to “gel” or set the suspension product via reacting with the clay.

Clays used in normal practice are expensive and are typically “pre-dispersed” in water prior to use to ensure effectiveness. They must then subsequently be “gelled” via phosphate, chloride, or sulfate addition bringing on additional expense. The expanded use of by-product feed components has essentially eliminated the need for phosphorus supplementation in practical cattle fattening rations and, in fact, phosphorus content of animal waste becomes the limiting factor in how much waste can be land applied. Elimination of the need for added phosphate would save cost and aid waste management by animal feedlots.

The advent of widespread use of ethanol distillers by-products will have a profound impact on the supplementation needs of animals fed these materials. Through the distilling process, concentrations of starch, fat, fiber, protein, phosphorus, and sulfur become concentrated in the resulting by-products.

When distillers by-products are included in rations for fattening beef, cattle-supplementary protein and phosphorus needs are significantly reduced or eliminated with regard to phosphorus. Because the distilling process includes use of sulfuric acid, sulfate levels are elevated in resulting distillers by-products, which can lead to nutritional problems relating to adverse effects on feed intake and a physiological thiamine deficiency.

This technology takes these considerations into account and involves the use of corn condensed distillers solubles with alkali to form a liquid suspension of a water-insoluble material. Product advantages include reduced cost as expensive clay and/or gum can be excluded, reduced availability of sulfate in the material due to the formation of calcium or other sulfate salts, elimination of expensive and undesired phosphate inclusion, elimination of need for buffering agents, and formation of fatty acid salts that have improved feeding characteristics in some cases.

As used herein, the words “comprise,” “has,” and “include” and all grammatical variations thereof are each intended to have an open, non-limiting meaning that does not exclude additional elements.

As used herein, except where specifically more particularly defined or limited, the term “liquid” means a liquid having a stirred viscosity of less than 50,000 cP when measured at a temperature between 68° F. (20° C.) and 80° F. (27° C.) and at a pressure of about 1 atm (100 kPa).

As used herein, except where specifically more particularly defined or limited, the term “suspension” (of the water-insoluble material) means that the mixture of insoluble solid and liquid phases does not readily separate into separate phases when observed standing without shaking or stirring.

As used herein, the term “liquid source of digestible organic matter” means a co-product from an industrial production process, e.g., chemical or food manufacturing. Such a co-product is often referred to as a by-product because it is substantially less valuable than the primarily desired product of an industrial production process. In the past, such a co-product or by-product may have had so little recognized value that it was often disposed of as undesired waste material. For example, in the production of ethanol, various co-products are typically obtained, which need to be disposed of or sold separately from the ethanol. Corn distillers solubles is a presently most-preferred example of a liquid source of digestible organic matter for use according to the present invention.

As used herein, the term “source of alkali” means a chemical that readily converts or reacts to provide an alkali. For example, calcium oxide (also known as lime or quicklime), when reacted with water (such as the water present in the liquid source of digestible organic matter) produces calcium hydroxide, an alkali. Thus, for the purposes of this invention, calcium oxide is considered to be a source of alkali.

As used herein, a “water-insoluble” means less than 1 weight percent soluble in distilled water when tested at a temperature between 68° F. (20° C.) and 80° F. (27° C.) and at a pressure of about 1 atm (100 kPa). As used herein, a “water-soluble” means more than 1 weight percent soluble in distilled water when tested at a temperature between 68° F. (20° C.) and 80° F. (27° C.) and at a pressure of about 1 atm (100 kPa).

When referring to a complex material, such as a natural product or a co-product from an industrial production process, while some components of the complex material may be water-soluble, if the bulk of the material comprises water-insoluble components, as used herein the material as a whole is considered to be a “water-insoluble material.”

It should be understood that as used herein the “water-insoluble material” refers to a water-insoluble material that is not inherently in the liquid source of digestible organic matter. For example, a presently most-preferred liquid source of digestible organic matter is corn condensed distillers solubles, which includes at least 4% crude fat on a dry-matter basis. Thus, while it is contemplated that crude fat can be admixed as a “water-insoluble material” in a step according to the methods of the present inventions, such admixed crude fat would be separate from or additional to any crude fat already present in the liquid source of digestible organic matter. Similarly, it should be understood that any reference to any other admixed material refers to a material that is not inherently present in the liquid source of digestible organic matter.

As used herein, the term “resulting mixture” means the product of the mixing steps of at least the specified and required ingredients according to a particular method of the invention.

As stated in the summary of the invention, according to one aspect of the invention, a method of preparing a liquid suspension is provided. According to this aspect, the method comprises mixing, simultaneously or in separate steps, at least: (a) a liquid source of digestible organic matter, wherein the liquid source of digestible organic matter comprises: (i) water in a concentration of at least 25% by weight of the liquid source of digestible organic matter; and (ii) digestible organic matter in a concentration of at least 5% by weight of the liquid source of digestible organic matter, wherein the digestible organic matter comprises starch in a concentration of at least 10% by weight on a dry-matter basis; and (b) at least a sufficient proportion of an alkali or alkali source to increase the stirred viscosity of the liquid source of digestible organic matter; and (c) a water-insoluble material selected from the group consisting of a nutrient, a medicament, and any combination thereof in any proportion.

According to another aspect of the invention, a method of preparing a liquid suspension comprising a water-insoluble carbonate is provided. According to this aspect, the method comprises mixing, simultaneously or in separate steps, at least: (a) a liquid source of digestible organic matter, wherein the liquid source of digestible organic matter comprises: (i) water in a concentration of at least 25% by weight of the liquid source of digestible organic matter; and (ii) digestible organic matter in a concentration of at least 5% by weight of the liquid source of digestible organic matter, wherein the digestible organic matter comprises crude fat in a concentration of at least 4% by weight on a dry-matter basis, wherein the liquid source of digestible organic matter has a stirred viscosity of at least 600 cP at a temperature between 68° F. (20° C.) and 80° F. (27° C.) and at a pressure of about 1 atm (100 kPa), and wherein the liquid source of digestible organic matter has a pH of less than 5.8; and (b) at least a sufficient proportion of a pH increasing agent to increase the pH of the liquid source of digestible organic matter to greater than or equal to 5.8; and (c) a water-insoluble material, wherein the water-insoluble material comprises carbonate selected from the group consisting of calcium carbonate, magnesium carbonate, and any combination thereof in any proportion.

### Nature of Liquid Source of Digestible Organic Matter

The selection of the liquid source of digestible organic matter is an important part of the invention. The methods according to the invention can further include a step of selecting the liquid source of digestible organic matter according to the various criterion specified for the liquid source. For example, the liquid source of digestible organic matter is selected for its ready availability and low cost as a co-product from an industrial production process.

It is contemplated that the liquid source of digestible organic matter may have an excessive concentration of water, such that a condensation step can be included in the methods according to the invention to obtain a liquid having a desired viscosity to help suspend a water-insoluble material. A typical step of condensing such a liquid source of digestible organic matter includes heating it to help remove some of the water. As will hereinafter be described in more detail, it is particularly advantageous according to the methods of the present invention to utilize such a liquid source of digestible organic matter while it is still at an elevated temperature from such a condensing step.

It is also contemplated that a step of mixing water with the liquid source of digestible organic matter can be included in the methods according to the invention to reduce an excessively high viscosity to a desired viscosity. In such case, the step of mixing with water to dilute the liquid source of digestible organic matter is preferably performed prior to the step of mixing with the alkali or the source of alkali and prior to the step of mixing with the water-insoluble material.

Preferably, the liquid source of digestible organic matter comprises crude fat in a concentration of at least 4% by weight on a dry-matter basis. Crude fat is a valuable nutritive ingredient. In addition to the nutritive value of crude fat, without being limited by any theoretical explanation, it is also believed that crude fat assists in forming a sufficient viscosity and other physical properties of the resulting mixture to help suspend the water-soluble material. It is believed that the alkali can saponify a constituent of the crude fat, such as free fatty acids, which may contribute to increasing the viscosity, suspending capability, and other physical characteristics of the resulting mixture. Treatment with alkali of the elevated crude fat levels in such a liquid source of digestible organic matter could also be useful for forming rumen “escape” fats via saponification. Formation of calcium salts of fatty acids actually results in a “higher” feeding value of the fat as this material can avoid ruminal metabolism while maintaining total gastrointestinal tract utilization. Triglycerides in the rumen are split by microbial enzymes leading to free fatty acids that can interfere with utilization of dietary fiber. Additionally, unsaturated fatty acids can be partially hydrogenated in the rumen yielding trans-fatty acids which may impact the normal functioning of adipose tissues.

The triglycerides present in the CCDS are also believed to hydrolyze in the presence of alkali, e.g., calcium hydroxide to yield glycerol and fatty acids. The fatty acids then saponify in the presence of the alkali to yield salts of fatty acids, i.e., soap. It is believed that the soap can interact with water to thicken and stabilize the mixture. Further, CCDS is believed to contain quantities of short chain free fatty acids as well, which also are believed to saponify to form calcium salts and lead to possible hydration reactions to help thicken and stabilize the resulting mixture.

By-product feed ingredients tend to accumulate all mineral components. Of particular interest is sulfur. Elevated levels of dietary sulfur can lead to situations of feed refusal and a condition in cattle known as polioencephalomalacia. Calcium sulfate, magnesium sulfate, sodium sulfate, or potassium sulfate formed as the neutralization product as described above is not as biologically available in the animal's digestive tract as “free sulfate” or the ammonium salt. Further, it is believed that the formation of calcium sulfate and its subsequent hydration helps in stabilizing the resulting mixture.

In an independent respect, without being limited by any theoretical explanation unless so specifically limited in a claim, preferably the liquid source of digestible organic matter is a liquid that does not separate into separate phases when observed standing without shaking or stirring for at least one day at a temperature between 68° F. (20° C.) and 80° F. (27° C.) and at a pressure of about 1 atm (100 kPa). More preferably, the liquid source of digestible organic matter is a liquid having a stirred viscosity of less than 5,000 cP when measured at a temperature between 68° F. (20° C.) and 80° F. (27° C.) and at a pressure of about 1 atm (100 kPa).

In another independent respect, and without necessarily being limited by any theoretical explanation unless so specifically limited in a claim, it is believed that starch is primarily responsible for the viscosity of such a liquid source of digestible organic matter as found in corn condensed distillers solubles. It is also believed that the starch is responsible for the nature of such a liquid source of digestible organic matter being able to have such an inherently-high fat content that does not separate when observed standing. Accordingly, it is believed that an important criterion for the selection of the liquid source of digestible organic matter is the presence of at least 10% starch on a dry-matter basis.

According to these various criteria and nutritive values, the liquid source of digestible organic matter preferably comprises a co-product of ethanol production, i.e., distillers solubles. More preferably, the distillers solubles comprises or is condensed distillers solubles. The predominating grain should be stated as the first word in the name of the distillers solubles or condensed distillers solubles. Examples of such distillers solubles or condensed distillers solubles include corn or potato condensed distillers solubles. Corn is generally preferable to potato according to the present invention based on the higher concentration of crude fat in corn condensed distillers solubles. More preferably, the condensed distillers solubles comprises corn distillers solubles (sometimes referred to as “CCDS”), which has a nutritive crude fat content of at least 4% on a dry-matter basis. Most preferably, the liquid source of digestible organic matter consists essentially of corn condensed distillers solubles.

For example, the liquid source of digestible organic matter is preferably produced by evaporating thin stillage removed from the mash in ethanol production to approximately 23%-50% by weight dry matter (50%-77% water). In the case of the most-preferred liquid source of digestible organic matter for use according to the invention, i.e., corn condensed distillers solubles, the CCDS typically has approximately 20%-30% crude protein on a dry-matter basis, 8%-25% crude fat on a dry-matter basis, 10%-60% NFE on a dry-matter basis, and 2%-5% crude fiber on a dry-matter basis; and 10%-50% starch on a dry-matter basis. The solubles are a good source of vitamins and minerals, including phosphorus.

### Nature of Alkali or Alkali Source

The alkali or alkali source is selected from the group consisting of calcium hydroxide, magnesium hydroxide, sodium hydroxide, potassium hydroxide, calcium oxide, and any combination thereof in any proportion. Most preferably, the alkali or alkali source is calcium hydroxide, which is relatively inexpensive, relatively easy to handle, and a source of nutritive calcium (after it is neutralized in an acid base reaction).

### Nature of Water-Insoluble Material

The water-insoluble material is preferably in a particulate form, e.g., finely ground or powdered or granular form. More preferably, the insoluble material has a mesh size of 20 or smaller. Inorganic water-insoluble material, such as calcium carbonate (e.g., limestone) preferably has a mesh size of 200 or smaller.

The preferred water-insoluble material is calcium carbonate, widely available as limestone, which is an inexpensive feed-grade source of nutritive calcium. Other water-insoluble material in particulate form that can be added includes, for example, any that can supply or supplement the animal's protein requirements such as: dried blood or meat meal from rendering plants, cottonseed meal, soybean meal, dehydrated alfalfa, dried and sterilized animal and poultry manure, powdered egg, and fishmeal.

The water-insoluble material has a tendency to increase the viscosity of the resulting mixture. For example, mixing CCDS and limestone tends to produce a paste with excessive viscosity.

### Additional Water-Soluble Nutrient

Preferably, the methods according to the invention further include, simultaneously or with any other step, mixing the liquid source of digestible organic matter with a water-soluble nutrient. Most preferably, the water-soluble nutrient is selected from the group consisting of urea, sodium chloride, potassium chloride, and any combination thereof in any proportion. Other water-soluble nutrient that can be added includes, for example, amino acids, vitamins, and minerals, such as calcium chloride, ammonium chloride, and magnesium chloride.

Preferably, the water-soluble nutrient is mixed in a dry form, e.g., powdered or granular form. More preferably, at least during the mixing of the liquid source of digestible organic matter with the water-soluble nutrient, the liquid source of a digestible organic matter is at a temperature of at least 100° F. (38° C.) to promote the dissolution of the water-soluble nutrient. Most preferably, the temperature is at least 120° F. (49° C.). The higher temperature assists in readily dissolving the water-soluble nutrient in the liquid source of digestible organic matter. As will hereinafter be discussed in more detail, the upper temperature limit for mixing is preferably about 165° F. (74° C.).

To avoid costs that would be associated with re-heating the liquid source of digestible organic matter, it is preferably mixed with at least the water-soluble nutrient immediately after the liquid source of digestible matter is produced and is still at a temperature of at least 100° F. (38° C.), and more preferably when the temperature is still at least 120° F. (49° C.).

Without being limited by any theoretical explanation, it is believed that the addition of water-soluble nutrient reduces the viscosity of the liquid source of digestible organic matter. Thus, even if the stirred viscosity of the liquid source of digestible organic matter is naturally already sufficiently high to suspend a desired concentration of a water-insoluble nutrient such as calcium carbonate, the addition of substantial amounts of a water-soluble nutrient such as salt and urea can reduce the natural viscosity to the point where the water-insoluble nutrient cannot be suspended without observing separation on standing. It is believed that adding the alkali or source of alkali reacts or interacts with the starch in the liquid source to increase the viscosity to help counteract the viscosity-reducing effect of adding such water-soluble nutrient.

### Mixing Sequence for Carbonate to Avoid Foaming

Preferably, the liquid source of digestible organic matter and the alkali or alkali source are mixed prior to mixing the liquid source of digestible organic matter with the water-insoluble material. This is especially preferable in cases where the liquid source of digestible organic matter has a pH less than 5.8 and is to be mixed with a calcium, magnesium, sodium, or potassium carbonate. Such a low pH can allow an acid-base reaction where the free acid in the liquid source of digestible organic matter can react with the carbonate causing carbon dioxide gas evolution and foaming of the resulting mixture. The liquid source of digestible organic matter and the alkali or alkali source is preferably mixed in proportion and under conditions to increase the pH of the liquid source of digestible organic matter to at least 5.8.

Without being limited by any theoretical explanation, it is believed that such a low pH can be at least partially attributed to the result of the process by which the liquid source of digestible organic matter is produced. For example, in the case of using corn condensed distillers solubles, sulfuric acid can have been used in the production of corn ethanol. It is also believed that, in some cases, the low pH of less than 5.8 can be at least partially attributed to the short-chain free fatty acids present that may be present in the liquid source of digestible organic material.

### Mixing Method for Carbonate to Manage Foaming

Even if the pH of the liquid source of digestible organic matter is less than 5.8, the foaming associated with mixing with carbonate can be managed by a suitable mixing method. For example, the mixer size can be selected to be sufficient to handle the increase in the volume produced by the reaction between the carbonate and the acidic component of the liquid source of digestible organic matter. According to another example, the mixing can be performed in a static mixer. A static mixer is a device for blending (mixing) two liquid materials. The device consists of mixer elements contained in a tubular housing. The tubular housing and the static mixer elements consist of a series of baffles that are made from metal or a variety of plastics. Typical materials of construction for the static mixer components include stainless steel, polypropylene, or fluoropolymers such as polytetrafluoroethylene (e.g., Teflon®), polyvinylidene difluoride (e.g., KYNAR® or HYLAR®), and polyacetal.

### Conditions Effective to Obtain Liquid Suspension

In general, the step or steps of mixing is or are performed such that the proportions of the liquid source of digestible organic matter, the alkali or alkali source, the water-insoluble material, and the conditions of mixing are sufficient to obtain a resulting mixture as a liquid suspension of the water-insoluble material that does not separate into separate phases when observed standing without shaking or stirring for at least one day at a temperature between 68° F. (20° C.) and 80° F. (27° C.) and at a pressure of about 1 atm (100 kPa). More preferably, the resulting mixture does not separate into separate phases when observed standing under such conditions for at least one week (i.e., seven days).

### Temperature to Help Pumpability and Mixing

At least during the mixing step or steps, the liquid source of digestible organic matter is at a temperature at least sufficient to maintain a stirred viscosity of less than 30,000 cp. More preferably, the temperature is at least sufficient to have the liquid source of digestible organic matter in with a sufficiently low viscosity that it can be pumped and mixed for at least the mixing of the methods according to the invention.

Accordingly, the liquid source of a digestible organic matter is preferably at a temperature of at least 100° F. (38° C.) to promote the pumpability. Most preferably, its temperature is at least 120° F. (49° C.).

To avoid costs that would be associated with re-heating the liquid source of digestible organic matter, it is preferably mixed with at least the water-soluble nutrient immediately after the liquid source of digestible matter is produced and is still at a temperature of at least 100° F. (38° C.), and more preferably when the temperature is still at least 120° F. (49° C.).

### Temperature for Starch Gelatinization

Starch gelatinization is a process that breaks down the intermolecular bonds of starch molecules in the presence of water and temperature and allows the hydrogen bonding sites (the hydroxyl hydrogen and oxygen) to engage more water. This penetration of water increases randomness in the general structure and decreases the number and the size of the crystalline region. The crystalline region does not allow water entry. When heat is applied, this region will be diffused, so that the chains start to pull out from each other. The region is, thus, called amorphous.

In this context, it is known that typical starches begin to gelatinize between 140° F.-158° F. (60° C.-70° C.), the more exact temperature dependent on the specific starch. For example, corn starch is reported to begin gelatinization between 144° F.-158° F. (62° C.-70° C.). However, it is also known that sugar and salt (i.e., sodium chloride) increase gelatinization temperature. Thus, residual sugars from a fermentation process from which a liquid source of digestible organic matter is obtained are likely to increase the gelatinization temperature of starch therein.

It is also noted that, in the case of distillers solubles, the distillation temperature for the ethanol-water azeotrope is about 173° F. (78° C.). Further, the process of condensing the distillers solubles in an evaporator is usually not conducted at a higher temperature, but rather at a temperature in the range of about 120° F.-150° F. (49° C.-66° C.). Thus, it is believed that some of the starch in condensed distillers solubles is probably not fully gelatinized.

Without being limited by any theoretical explanation, it is believed that the alkali or alkali source reduces the gelatinization temperature of non-gelatinized starch that may be present in the source of digestible organic matter.

According to the invention, the alkali or alkali source is believed to reduce the gelatinization temperature. For example, calcium hydroxide itself is also known to reduce the gelatinization temperature of starch down to about 120° F. (49° C.). Sodium hydroxide is known to reduce the gelatinization temperature down to about 104° F.-122° F. (40° C.-50° C.). Further, chaotropic agents are also known to reduce the gelatinization temperature. For example, calcium chloride, which is likely to be formed by the addition of calcium hydroxide to the liquid source of digestible organic matter, is another chaotropic agent. In addition, urea is also known to be a chaotropic agent that can reduce the gelatinization temperature of starch. This invention recognizes the usefulness of these combinations with a liquid source of digestible organic matter having starch therein.

According to preferred methods of the invention, the alkali or alkali source is mixed with the liquid source of digestible organic matter at a temperature within the range of 120° F.-150° F. (49° C.-66° C.). Further, according to preferred methods of the invention utilizing urea, it is believed to be preferable to mix the urea while the liquid source of digestible organic matter is in this same temperature range to help with dissolution of the urea and to lower the gelatinization temperature of the starch. Most preferably, however, it is believed that salt (sodium chloride), which is known to increase the gelatinization temperature of starch, and any other water-soluble material that increases the gelatinization temperature of starch should preferably be added after and separately from the alkali or alkali source and preferably after the addition of any urea so as to first promote gelatinization to increase the viscosity of the resulting mixture.

### Upper Temperature Limit to Avoid Caramelization

Preferably, the liquid source of digestible organic matter is at a temperature of at most 165° F. (74° C.) to avoid caramelization of any sugars that may be naturally present in or admixed with the liquid source of digestible organic matter.

Accordingly, the liquid source of digestible organic matter is preferably at a temperature in the range of 100° F.-165° F. (38° C.-74° C.) when mixed with the water-soluble nutrient, and more preferably in the range of 120° F.-150° F. (49° C.-66° C.).

To avoid costs that would be associated with re-heating the liquid source of digestible organic matter, it is preferably mixed with at least the water-soluble nutrient immediately after the liquid source of digestible matter is produced and is still at a temperature of at least 100° F. (38° C.), and more preferably when its temperature is still at least 120° F. (49° C.).

### Controlling pH

The steps of mixing are under conditions to maintain the pH of the liquid source of digestible organic matter and the resulting mixture at a pH equal to or less than 8.5. More preferably, the steps of mixing are under conditions to maintain the pH of the liquid source of digestible organic matter and the resulting mixture at a pH of less than 7.5. The purpose of maintaining a pH of less than 8.5, and more preferably less than 7.5, is to minimize volatilization of ammonia from protein or urea, which improves palatability and minimizes protein loss.

### Method and Resulting Mixture Free From Undesirable Ingredients

The resulting mixture is substantially free of admixed non-digestible matter. For example, the resulting mixture is preferably substantially free of any non-digestible viscosity-increasing agent. Typical viscosity-increasing agents include non-nutritive viscosifying gums, e.g., xanthan, or clay, e.g., attapulgite (also known as palygorskite). A disadvantage of such non-nutritive viscosity-increasing agents is that they provide bulk but no nutrition. The added bulk adds to shipping and handling costs and also adds to the amount of solid waste produced by the animal by eating such non-digested materials. The additional amount of solid waste adds to disposal costs and environmental concerns. The present invention does not require the use of such non-nutritive viscosity-increasing agents and can be used to avoid the problems associated with admixing such non-nutritive materials into a liquid suspension for use with animal feed.

Preferably, the resulting mixture is substantially free of admixed phosphorous (e.g., ammonium polyphosphate and phosphoric acid). While phosphorous is a nutrient, in an animal feedlot for a ruminant, there are other sources of phosphorous such that the excess is becoming an environmental problem. Adding phosphorous to a liquid suspension for use with animal feed has generally become undesirable.

Further, the resulting mixture is preferably substantially free of admixed sulfate. While sulfate is a nutrient, in an animal feedlot for a ruminant, there are other sources of sulfate. In particular, where the liquid source of digestible organic matter is distillers solubles, sulfuric acid is likely to have been used in the process of the ethanol production. Sulfuric acid is a source of sulfate. Excess sulfate in the diet can cause animal health problems. For example, excess sulfate in the diet is associated with polioencephalomalacia in ruminants.

### Physical Properties of Resulting Mixture

The water-insoluble material is positionally stable as a suspension in the resulting mixture. The positional stability can be tested by determining and comparing the concentration of the water-insoluble material in samples of the resulting mixture taken from a lower portion, a middle portion, and an upper portion of the resulting mixture that does not separate into separate phases when observed standing without shaking or stirring for one day at a temperature between 68° F. (20° C.) and 80° F. (27° C.) and at a pressure of about 1 atm (100 kPa). The concentrations of the water-insoluble material in each of the samples taken from the different portions, respectively, of the resulting material after standing for one day should be substantially the same.

The mixing proportions and conditions are selected to obtain a resulting mixture have desirable dry-matter content and physical characteristics. For example, the methods according to the invention are preferably performed with ingredients and under conditions such that the resulting mixture most preferably has a dry-matter concentration in the range of 50%-70% by weight.

Preferably, the resulting mixture is a pumpable liquid. More preferably, the resulting mixture has a stirred viscosity of between 600 cP-4,000 cP when measured at a temperature in the range of 68° F. (20° C.)-80° F. (27° C.) and about 1 atmosphere (100 kPa) pressure. More preferably, the resulting mixture has a stirred viscosity of between 750 cP to 2,500 cP when measured under such conditions. Most preferably, the resulting mixture is thixotropic.

### Including the Resulting Mixture in a Feed Ration for an Animal

According to preferred aspects of the invention, the methods further include the step of including the resulting mixture in either a feed ration for an animal or in “free choice” feeding applications. The methods are most advantageously employed where the step of including the resulting mixture in a feed ration for an animal further includes the step of feeding the feed ration in a confined animal feeding operation, such as a feedlot or dairy. Alternatively, for example, the mixture itself could be placed in specially designed feeders for pasture applications.

### Additional Aspects and Embodiments

According to another aspect of the invention, a method of preparing a liquid suspension including a carbonate is provided. According to this aspect, the method comprises the steps of: (a) mixing: (i) a liquid source of digestible organic matter, wherein the liquid source of digestible organic matter comprises condensed distillers solubles, wherein the liquid source of digestible organic matter has a stirred viscosity of at least 600 cP at a temperature between 68° F. (20° C.) and 80° F. (27° C.) and at a pressure of about 1 atm (100 kPa), and wherein the liquid source of digestible organic matter has a pH of less than 5.8; (ii) at least a sufficient proportion of a pH increasing agent to increase the pH of the liquid source of digestible organic matter to greater than or equal to 5.8, wherein the pH increasing agent comprises an alkali or alkali source selected from the group consisting of calcium hydroxide, sodium hydroxide, potassium hydroxide, magnesium hydroxide, calcium oxide, magnesium oxide, and any combination thereof in any proportion; and (b) thereafter, mixing with the condensed distillers solubles a water-insoluble material, wherein the water-insoluble material comprises carbonate selected from the group consisting of calcium carbonate, magnesium carbonate, and any combination thereof in any proportion.

The method preferably further includes the step of mixing a water-soluble nutrient selected from the group consisting of urea, sodium chloride, calcium chloride, potassium chloride, magnesium chloride, and any combination thereof in any proportion with the condensed distillers solubles.

The steps of mixing are preferably performed immediately after the condensed distillers solubles is produced and is still at a temperature of at least 100° F. (38° C.), and more preferably while still at a temperature of at least 120° F. (49° C.).

More preferably, the condensed distillers solubles comprises corn condensed distillers solubles. Most preferably, the condensed distiller solubles consists essentially of corn condensed distillers solubles.

The resulting mixture preferably has a sufficiently low viscosity that is a pumpable liquid. Most preferably, the resulting mixture has a dry-matter concentration in the range of 50%-70% by weight and a stirred viscosity of between 600-4,000 cP when measured at a temperature in the range of 68° F. (20° C.)-80° F. (27° C.) and about 1 atmosphere (100 kPa) pressure.

According to yet another aspect and embodiment of the invention, a method of preparing a liquid suspension is provided, where the method comprises the step of mixing at least: (a) a liquid source of digestible organic matter, wherein the liquid source of digestible organic matter comprises: (i) water in a concentration of at least 25% by weight of the liquid source of digestible organic matter; and (ii) digestible organic matter in a concentration of at least 5% by weight of the liquid source of digestible organic matter, and (iii) starch in a concentration of at least 10% by weight on a dry-matter basis, and wherein the liquid source of digestible organic matter has a stirred viscosity of at least 600 cP at a temperature between 68° F. (20° C.) and 80° F. (27° C.) and at a pressure of about 1 atm (100 kPa); (b) a water-soluble nutrient; and (c) a water-insoluble material, wherein the water-insoluble material comprises carbonate selected from the group consisting of calcium carbonate, magnesium carbonate, and any combination thereof in any proportion. The mixing proportions are such that the resulting mixture has a dry-matter concentration in the range of 50%-70% by weight and a stirred viscosity of between 600-4,000 cP when measured at a temperature in the range of 68° F. (20° C.)-80° F. (27° C.) and about 1 atmosphere (100 kPa) pressure.

### EXPERIMENTAL AND EXAMPLES

We have observed that corn condensed distillers solubles (“CCDS”) is capable of producing a suspending characteristic that previously commonly has been seen with clays and/or gums. Several different mixture formulations were made to try to identify the component within the CCDS responsible for producing a suspending characteristic.

Materials and equipment used were relatively simple, including ingredients (e.g., CCDS, corn steep liquor, oil, limestone, salt, potassium chloride, urea, and calcium hydroxide), five-gallon mixing buckets, positional stability columns (i.e., 4 inch (10 cm) PVC pipe, 3.5 feet (1 m) long having a one inch (2.5 cm) valve at the bottom, a removable cap at the top, and a one inch (2.5 cm) valve near the middle), sample bottles, high sheer lab mixer, viscometer, pH meter, refractometer, calorimetric spectroscopy (e.g., Hach Digesting Equipment for Feed and Forage Analysis), and suitable reagents to test for nutrients.

The mixtures according to the test formulations were generally produced by mixing all of the dry components together into a dry premix that was then added to the liquid fraction that had been heated to 135° F.-140° F. (57° C.-60° C.). This temperature range was chosen primarily because this is the typical temperature at which the CCDS stream leaves an ethanol plant. Other factors regarding the selection of the temperature range for the mixing steps have been discussed above.

Prior experience with acidic liquid ingredients and limestone indicated that we should raise the pH of the liquid fraction to a pH of at least 5.0 before combining the liquid and dry mixtures to prevent a large volume increase due to the release of carbon dioxide. More preferably, the pH should be raised to at least 5.8 for this reason.

To facilitate the blending of some of the formulas listed in the tables below, the sequence of the mixing steps was modified. In all cases the urea, salt, potassium chloride, and limestone were mixed together to form the dry premix. When calcium hydroxide was present in the formulas, it was added to the liquid fraction to adjust the pH prior to the addition of the dry premix. In all formulations that contained the calcium hydroxide and water, a slurry was created prior to the addition to the other liquid fraction. This was done to better facilitate mixing of the calcium hydroxide into the liquid portion of the mix. The CCDS “Pos” formula required that the calcium hydroxide be added directly to the CCDS because there was no additional water in the formula. This was done very slowly to minimize the occurrence of calcium hydroxide clumps. Once the calcium hydroxide had been added to the mixture, the remaining dry ingredients were added.

All formulas were mixed with moderate mixing speed using a top entry laboratory mixer for five minutes.

TABLE 1
CCDS/Base Test Formulas

| | CCDS | CCDS | CCDS | CCDS |
|---|---|---|---|---|
| Ingredient | Neg Base | Pos Ca(OH)2 | Pos NaOH | Pos Aq. NH3 |
| CCDS | 60.23 | 60.67 | 60.67 | 60.67 |
| Urea | 10 | 10 | 10 | 10 |
| KCl | 3 | 3 | 3 | 3 |
| NaCl | 4 | 4 | 4 | 4 |
| Ca(OH)₂ | 0 | 0.83 | 0 | 0 |
| NaOH | 0 | 0 | 0.83 | 0 |
| Aq. NH3 | 0 | 0 | 0 | 0.83 |
| (26° Baume) | | | | |
| Limestone | 22.77 | 21.5 | 21.5 | 21.5 |
| Molasses | 0 | 0 | 0 | 0 |
| Water | 0 | 0 | 0 | 0 |
| Corn Steep | 0 | 0 | 0 | 0 |
| Liquor | | | | |
| Veg. Oil | 0 | 0 | 0 | 0 |
| Corn Starch | 0 | 0 | 0 | 0 |

TABLE 2
Corn Steep Liquor/Fat Test Formulas

| | Corn Steep | Corn Steep | Corn Steep |
|---|---|---|---|
| Ingredient | Neg Fat | ½ Fat | Full Fat |
| CCDS | | | |
| Urea | 10 | 10 | 10 |
| KCl | 3 | 3 | 3 |
| NaCl | 4 | 4 | 4 |
| Ca(OH)₂ | 0.83 | 0.83 | 0.83 |
| Limestone | 21.5 | 21.5 | 21.5 |
| Molasses | 0 | 0 | 0 |
| Water | 16.17 | 16.17 | 16.17 |
| Corn Steep Liquor | 44.5 | 43 | 41.5 |
| Veg. Oil | 0 | 1.5 | 3 |
| Corn Starch | 0 | 0 | 0 |

TABLE 3
Molasses/Fat Test Formulas

| | Molasses | Molasses | Molasses |
|---|---|---|---|
| Ingredient | Neg Fat | ½ Fat | Full Fat |
| CCDS | 0 | 0 | 0 |
| Urea | 10 | 10 | 10 |
| KCl | 3 | 3 | 3 |
| NaCl | 4 | 4 | 4 |
| Ca(OH)₂ | 0.83 | 0.83 | 0.83 |
| Limestone | 21.5 | 21.5 | 21.5 |
| Molasses | 27.5 | 26 | 24.5 |
| Water | 33.17 | 33.17 | 33.17 |
| Corn Steep Liquor | 0 | 0 | 0 |
| Veg. Oil | 0 | 1.5 | 3 |
| Corn Starch | 0 | 0 | 0 |

TABLE 4
Oil/Ca(OH)2 Test Formulas

| | Oil | Oil | Oil |
|---|---|---|---|
| Ingredient | Neg Ca(OH)2 | 1.25% Ca(OH)₂ | 2.5% Ca(OH)₂ |
| CCDS | 0 | 0 | 0 |
| Urea | 10 | 10 | 10 |
| KCl | 3 | 3 | 3 |
| NaCl | 4 | 4 | 4 |
| Ca(OH)₂ | 0 | 1.25 | 2.5 |
| Limestone | 22 | 20.75 | 19.5 |
| Molasses | 0 | 0 | 0 |
| Water | 41 | 41 | 41 |
| Corn Steep | 0 | 0 | 0 |
| Liquor | | | |
| Veg. Oil | 20 | 20 | 20 |
| Corn Starch | 0 | 0 | 0 |

TABLE 5
Corn Steep Liquor/Starch Test Formulas

| | Corn | Corn | Corn | | |
|---|---|---|---|---|---|
| | Steep | Steep | Steep | | Corn Steep |
| | Neg | 0.25% | 0.5% | Corn Steep | 1.0% Starch |
| Ingredient | Starch | Starch | Starch | 1.0% Starch | Neg Ca(OH)2 |
| CCDS | 0 | 0 | 0 | 0 | 0 |
| Urea | 10 | 10 | 10 | 10 | 10 |
| KCl | 3 | 3 | 3 | 3 | 3 |
| NaCl | 4 | 4 | 4 | 4 | 4 |
| Ca(OH)₂ | 0.83 | 0.83 | 0.83 | 0.83 | 0 |
| Limestone | 21.5 | 21.5 | 21.5 | 21.5 | 21.5 |
| Molasses | 0 | 0 | 0 | 0 | 0 |
| Water | 17.17 | 17.42 | 17.67 | 18.17 | 17.16 |
| Corn Steep | 43.5 | 43.0 | 42.5 | 41.5 | 43.34 |
| Liquor | | | | | |
| Veg. Oil | 0 | 0 | 0 | 0 | 0 |
| Corn Starch | 0 | 0.25 | 0.5 | 1.0 | 1.0 |

TABLE 6
Cane Molasses/Starch Test Formulas

| | Cane | Cane | Cane |
|---|---|---|---|
| Ingredient | Neg Starch | 0.5% Starch | 1.0% Starch |
| Cane | 27.56 | 26.92 | 26.28 |
| Molasses | | | |
| Water | | | |
| Urea | 10 | 10 | 10 |
| KCl | 3 | 3 | 3 |
| NaCl | 4 | 4 | 4 |
| Ca(OH)₂ | 0.83 | 0.83 | 0.83 |
| Limestone | 21.5 | 21.5 | 21.5 |
| Water | 33.11 | 33.25 | 33.39 |
| Corn Steep | 0 | 0 | 0 |
| Liquor | | | |
| Veg. Oil | 0 | 0 | 0 |
| Corn Starch | 0 | 0.5 | 1.0 |

Evaluation of the various test formulas by visual examination and viscosity measurements revealed the following data.

TABLE 7
Viscosity and Appearance Data for Text Samples

| | | Viscosity | Temperature | |
|---|---|---|---|---|
| | Formula | cP | (° F.) | Appearance Next Day |
| | CCDS | 2000 | 77 | Slightly Swollen Bottle. Appears Homogenous |
| | Neg Base | | | |
| | CCDS | 2630 | 77.2 | Appears Homogenous |
| | Pos Ca(OH)2 | | | |
| | CCDS | 4630 | 78.9 | ??? |
| | Pos NaOH | | | |
| | CCDS | 2320 | 78.4 | ??? |
| | Pos Aq. NH3 | | | |
| | Corn Steep | 500 | 77.2 | Slight Separation at the Surface. Most likely oil |
| | Neg Fat | | | or possibly water |
| | Corn Steep ½ Fat | 390 | 77 | Slight Separation at the Surface. Most likely oil |
| | | | | or possibly water |
| | Corn Steep | 275 | 77.1 | Slight Separation at the Surface. Most likely oil |
| | Full Fat | | | or possibly water |
| | Molasses Neg Fat | 15 | 77.4 | Two layers. Calcium appears to be settling out |
| | Molasses ½ Fat | 15 | 77 | Three layers. Top layer appears to be foam. |
| | | | | Bottom layer appears to be limestone |
| | Molasses Full Fat | 15 | 77 | Three layers. Top layer appears to be foam. |
| | | | | Bottom layer appears to be limestone |
| | Oil Neg Ca(OH)2 | 100 | 77.6 | Three layers. Top layer appears to be oil. Middle |
| | | | | layer is water and dissolved solids. Bottom layer |
| | | | | appears to be limestone |
| | Oil 1.25% Ca(OH)2 | NA | NA | Turned into a paste. Oil blended into Steep then |
| | | | | Ca(OH) added |
| | Oil 2.5% Ca(OH)2 | NA | NA | Turned into a paste. Oil blended into Steep then |
| | | | | Ca(OH) added |
| | Oil 1.25% Ca(OH)2 | 280 | 77.8 | Changed Mix Order; Oil Added Last. Also used |
| | | | | food grade oil and known FFA acid Oil |
| | Oil 2.5% Ca(OH)2 | 310 | 77.8 | Changed Mix Order; Oil Added Last. Also used |
| | | | | food grade oil and known FFA acid Oil |
| Day 0 | Corn Steep | 270 | 75.2 | |
| | Neg Starch | | | |
| Day 0 | Corn Steep | 390 | 75.2 | Slight separation at the surface. Most likely |
| | 0.25% Starch | | | water layer. |
| Day 0 | Corn Steep | 500 | 74.9 | Slight separation at the surface. Most likely |
| | 0.5% Starch | | | water layer. |
| Day 0 | Corn Steep | 550 | 75.1 | Slight separation at the surface. Most likely |
| | 1.0% Starch | | | water layer. |
| Day 0 | Corn Steep | 480 | 75.2 | Slight separation at the surface. Most likely |
| | 1.0% Starch | | | water layer. |
| | Neg Ca(OH)2 | | | |
| Day 7 | Corn Steep | 670 | 74.6 | Two definite layers |
| | Neg Starch | | | |
| Day 7 | Corn Steep | 1040 | 74.5 | Sample appears to have gelled. Bottle can be |
| | 0.25% Starch | | | inverted and sample remains stable, upon shaking |
| | | | | it begins to flow. |
| Day 7 | Corn Steep | 1120 | 74.5 | Sample appears to have gelled. Bottle can be |
| | 0.5% Starch | | | inverted and sample remains stable, upon shaking |
| | | | | it begins to flow. |
| Day 7 | Corn Steep | 1290 | 75.1 | Sample appears to have gelled. Bottle can be |
| | 1.0% Starch | | | inverted and sample remains stable, upon shaking |
| | | | | it begins to flow. |
| Day 7 | Corn Steep | 1160 | 74.8 | Sample appears to have gelled. Bottle can be |
| | 1.0% Starch | | | inverted and sample remains stable, upon shaking |
| | Neg Ca(OH)2 | | | it begins to flow. |
| | Cane Molasses | 30 | 78 | Very thin. Separated quickly. |
| | Neg Starch | | | |
| | Cane Molasses | 30 | 78.1 | Very thin. Separated quickly. |
| | 0.5% Starch | | | |
| | Cane Molasses | 30 | 78.2 | Very thin. Separated quickly. |
| | 1.0% Starch | | | |

From this data, we can ascertain that the primary component contributing to the suspension-like characteristics is the residual starch in the CCDS. Secondarily, it is believed that there is a reaction between the free fatty acids inherent to the CCDS and the added calcium from either the calcium hydroxide or the limestone. The data indicates that a similar response is achieved regardless of whether or not the calcium hydroxide is present indicating that its primary function is to buffer the matrix up so the limestone can be added without gas evolution and foaming. The samples that contained the calcium hydroxide did show a slightly higher viscosity than the samples made without calcium hydroxide and just limestone, which is believed to indicate that there is a reaction between the fat or the residual starch. Day seven inspection of the samples revealed much higher viscosities and a very stable suspension. Agitation was required to create a flowable liquid.

Two different types of fat extraction methods can be used to determine whether s whether the calcium hydroxide is reacting with any free fatty acid component of the CCDS. An ether extraction can be used to extract fat, but will generally not extract soap. An acid hydrolysis extraction method can be used, which will convert soap to fat and then extract the fat. If the acid hydrolysis extraction method extracts more fat than the ether extraction method, the difference can be attributable to the presence of soap. The presence of soap would indicate reaction between the calcium hydroxide and the free fatty acid component of the CCDS.

Positional stability can be determined in a positional stability column. For example, a sample from the resulting mixture of each formula can be taken from the top, middle, and bottom of the positional stability column at time 0, and at day 3, 7, 10, and 14. Samples can be tested for viscosity, moisture, pH, refractive index, protein, phosphorus, calcium, and magnesium. The samples can also be tested for the concentration of water-insoluble material to determine the positional stability of the resulting mixture from each formula and mixing procedure. For a positionally stable formula, the concentration of the water-insoluble material should be substantially the same for each sample taken from the top, middle, and bottom of the column and for the desired period of time.

The following formulas of Table 8 were used to test for comparison of the amount of fact obtained from the two different types of fat extraction methods and for positional stability testing.

TABLE 8
Formulas Tested for Fat Extraction Methods and Positional Stability

| | 0.83 Ca(OH)2/ | 1.65 Ca(OH)2/ | 0.46 Ca(OH)2/ | 0.93 Ca(OH)2/ | 1.39 Ca(OH)2/ |
|---|---|---|---|---|---|
| | HighCa/ | High Ca/ | Low Ca/ | Low Ca/ | Low Ca/ |
| Ingredient | High Urea | High Urea | Low Urea | Low Urea | Low Urea |
| CCDS | 60.67 | 60.67 | 76.9 | 77.63 | 78.39 |
| Urea | 10.0 | 10.0 | 5.00 | 5.00 | 5.00 |
| KCl | 3.00 | 3.00 | 2.86 | 2.86 | 2.86 |
| NaCl | 4.00 | 4.00 | 2.86 | 2.86 | 2.86 |
| Ca(OH)₂ | 0.83 | 1.67 | 0.46 | 0.93 | 1.39 |
| Limestone | 21.5 | 20.66 | 11.94 | 10.72 | 9.50 |

Table 9 summarizes and compares the data obtained from ether extract and acid hydrolysis methods for the extraction of fat. The data shows that more fat was extracted using the acid hydrolysis method, which indicates that the calcium hydroxide is reacting with free fatty acid in the CCDS to form soap. It is believed that this soap formation contributes to the viscosity and suspending characteristics of the resulting mixture.

TABLE 9
Fat Extraction Method Comparison Data

| | | | Ether | Acid | |
|---|---|---|---|---|---|
| | % Ca from | | Extract | Hydrolysis | |
| | CaOH | DAY | Method | Method | Ratio |
| 0.46 Ca(OH)2/Low Ca/Low Urea | 5 | 3 | 4.23 | 6.91 | 0.612156 |
| 0.93 Ca(OH)2/Low Ca/Low Urea | 10 | 3 | 4.31 | 5.37 | 0.802607 |
| 1.39 Ca(OH)2/Low Ca/Low Urea | 15 | 3 | 6.75 | 7.25 | 0.931034 |
| 0.83 Ca(OH)2/HighCa/High Urea | 5 | 3 | 3.17 | 4.57 | 0.693654 |
| 1.65 Ca(OH)2/HighCa/High Urea | 10 | 3 | 2.86 | 4.41 | 0.648526 |
| 0.46 Ca(OH)2/Low Ca/Low Urea | 5 | 14 | 5.53 | 7.55 | 0.732450 |
| 0.93 Ca(OH)2/Low Ca/Low Urea | 10 | 14 | 5.43 | 6.97 | 0.779053 |
| 1.39 Ca(OH)2/Low Ca/Low Urea | 15 | 14 | 6.87 | 7.46 | 0.920912 |
| 0.83 Ca(OH)2/HighCa/High Urea | 5 | 14 | 2.14 | 4.71 | 0.454352 |
| 1.65 Ca(OH)2/HighCa/High Urea | 10 | 14 | 3.22 | 4.53 | 0.710817 |

TABLE 10
Positional Stability Results for Calcium
(Including Calcium Carbonate)

| | | Column | | Calcium |
|---|---|---|---|---|
| Sample ID | Day | Position | pH | wt % |
| 0.83 Ca(OH)2/High Ca/High Urea | 0 | NA | 7.45 | 8.31 |
| 0.83 Ca(OH)2/High Ca/High Urea | 3 | Top | 7.47 | 8.29 |
| 0.83 Ca(OH)2/High Ca/High Urea | 7 | Top | 7.41 | 7.8 |
| 0.83 Ca(OH)2/High Ca/High Urea | 10 | Top | 7.51 | 8.34 |
| 0.83 Ca(OH)2/High Ca/High Urea | 14 | Top | 7.43 | 7.44 |
| 0.83 Ca(OH)2/High Ca/High Urea | 3 | Middle | 7.48 | 8.44 |
| 0.83 Ca(OH)2/High Ca/High Urea | 7 | Middle | 7.36 | 7.98 |
| 0.83 Ca(OH)2/High Ca/High Urea | 10 | Middle | 7.5 | 8.35 |
| 0.83 Ca(OH)2/High Ca/High Urea | 14 | Middle | 7.42 | 7.41 |
| 0.83 Ca(OH)2/High Ca/High Urea | 3 | Bottom | 7.42 | 8.73 |
| 0.83 Ca(OH)2/High Ca/High Urea | 7 | Bottom | 7.41 | 8.13 |
| 0.83 Ca(OH)2/High Ca/High Urea | 10 | Bottom | 7.41 | 8.58 |
| 0.83 Ca(OH)2/High Ca/High Urea | 14 | Bottom | 7.25 | 7.34 |
| | | Average | 7.42 | 8.09 |
| | | Std Dev | 0.07 | 0.46 |
| | | CV | 0.90 | 5.68 |
| 1.65 Ca(OH)2/High Ca/High Urea | 0 | NA | 9.72 | 9.61 |
| 1.65 Ca(OH)2/High Ca/High Urea | 3 | Top | 9.73 | 9.37 |
| 1.65 Ca(OH)2/High Ca/High Urea | 7 | Top | 9.67 | 8.75 |
| 1.65 Ca(OH)2/High Ca/High Urea | 10 | Top | 9.63 | 9.31 |
| 1.65 Ca(OH)2/High Ca/High Urea | 14 | Top | 9.49 | 8.24 |
| 1.65 Ca(OH)2/High Ca/High Urea | 3 | Middle | 9.72 | 9.33 |
| 1.65 Ca(OH)2/High Ca/High Urea | 7 | Middle | 9.68 | 9.18 |
| 1.65 Ca(OH)2/High Ca/High Urea | 10 | Middle | 9.7 | 9.41 |
| 1.65 Ca(OH)2/High Ca/High Urea | 14 | Middle | 9.56 | 8 |
| 1.65 Ca(OH)2/High Ca/High Urea | 3 | Bottom | 9.73 | 9.62 |
| 1.65 Ca(OH)2/High Ca/High Urea | 7 | Bottom | 9.65 | 8.64 |
| 1.65 Ca(OH)2/High Ca/High Urea | 10 | Bottom | 9.68 | 9.54 |
| 1.65 Ca(OH)2/High Ca/High Urea | 14 | Bottom | 9.49 | 8.37 |
| | | Average | 9.65 | 9.03 |
| | | Std Dev | 0.09 | 0.56 |
| | | CV | 0.88 | 6.19 |
| 0.46 Ca(OH)2/Low Ca/Low Urea | 0 | NA | 5.76 | 5.08 |
| 0.46 Ca(OH)2/Low Ca/Low Urea | 3 | Top | 5.58 | 4.86 |
| 0.46 Ca(OH)2/Low Ca/Low Urea | 7 | Top | 5.73 | 5.03 |
| 0.46 Ca(OH)2/Low Ca/Low Urea | 10 | Top | 5.84 | 5.26 |
| 0.46 Ca(OH)2/Low Ca/Low Urea | 14 | Top | 5.71 | 1.65 |
| 0.46 Ca(OH)2/Low Ca/Low Urea | 3 | Middle | 5.62 | 4.97 |
| 0.46 Ca(OH)2/Low Ca/Low Urea | 7 | Middle | 5.73 | 4.61 |
| 0.46 Ca(OH)2/Low Ca/Low Urea | 10 | Middle | 5.53 | 5.12 |
| 0.46 Ca(OH)2/Low Ca/Low Urea | 14 | Middle | 5.76 | 4.73 |
| 0.46 Ca(OH)2/Low Ca/Low Urea | 3 | Bottom | 5.63 | 4.85 |
| 0.46 Ca(OH)2/Low Ca/Low Urea | 7 | Bottom | 5.74 | 2.94 |
| 0.46 Ca(OH)2/Low Ca/Low Urea | 10 | Bottom | 5.86 | 5.39 |
| 0.46 Ca(OH)2/Low Ca/Low Urea | 14 | Bottom | 5.74 | 4.92 |
| | | Average | 5.71 | 4.57 |
| | | Std Dev | 0.10 | 1.06 |
| | | CV | 1.68 | 23.28 |
| 0.93 Ca(OH)2/Low Ca/Low Urea | 0 | NA | 6.27 | 6.59 |
| 0.93 Ca(OH)2/Low Ca/Low Urea | 3 | Top | 6.22 | 4.55 |
| 0.93 Ca(OH)2/Low Ca/Low Urea | 7 | Top | 6.42 | 4.02 |
| 0.93 Ca(OH)2/Low Ca/Low Urea | 10 | Top | 6.58 | 4.87 |
| 0.93 Ca(OH)2/Low Ca/Low Urea | 14 | Top | 6.63 | 4.21 |
| 0.93 Ca(OH)2/Low Ca/Low Urea | 3 | Middle | 6.21 | 4.5 |
| 0.93 Ca(OH)2/Low Ca/Low Urea | 7 | Middle | 6.33 | 4.04 |
| 0.93 Ca(OH)2/Low Ca/Low Urea | 10 | Middle | 6.35 | 4.67 |
| 0.93 Ca(OH)2/Low Ca/Low Urea | 14 | Middle | 6.21 | 4.32 |
| 0.93 Ca(OH)2/Low Ca/Low Urea | 3 | Bottom | 6.23 | 4.56 |
| 0.93 Ca(OH)2/Low Ca/Low Urea | 7 | Bottom | 6.27 | 4.24 |
| 0.93 Ca(OH)2/Low Ca/Low Urea | 10 | Bottom | 6.34 | 5.17 |
| 0.93 Ca(OH)2/Low Ca/Low Urea | 14 | Bottom | 6.24 | 4.14 |
| | | Average | 6.33 | 4.61 |
| | | Std Dev | 0.14 | 0.68 |
| | | CV | 2.17 | 14.83 |
| 1.39 Ca(OH)2/Low Ca/Low Urea | 0 | NA | 7.39 | 4.4 |
| 1.39 Ca(OH)2/Low Ca/Low Urea | 3 | Top | 7.37 | 4.33 |
| 1.39 Ca(OH)2/Low Ca/Low Urea | 7 | Top | 8.01 | 4.17 |
| 1.39 Ca(OH)2/Low Ca/Low Urea | 10 | Top | 7.36 | 4.52 |
| 1.39 Ca(OH)2/Low Ca/Low Urea | 14 | Top | 8.74 | 3.88 |
| 1.39 Ca(OH)2/Low Ca/Low Urea | 3 | Middle | 7.37 | 4.33 |
| 1.39 Ca(OH)2/Low Ca/Low Urea | 7 | Middle | 7.35 | 4.41 |
| 1.39 Ca(OH)2/Low Ca/Low Urea | 10 | Middle | 7.45 | 4.41 |
| 1.39 Ca(OH)2/Low Ca/Low Urea | 14 | Middle | 7.21 | 3.99 |
| 1.39 Ca(OH)2/Low Ca/Low Urea | 3 | Bottom | 7.38 | 4.38 |
| 1.39 Ca(OH)2/Low Ca/Low Urea | 7 | Bottom | 7.36 | 4.11 |
| 1.39 Ca(OH)2/Low Ca/Low Urea | 10 | Bottom | 8.46 | 4.48 |
| 1.39 Ca(OH)2/Low Ca/Low Urea | 14 | Bottom | 7.15 | 3.99 |
| | | Average | 7.58 | 4.26 |
| | | Std Dev | 0.50 | 0.21 |
| | | CV | 6.55 | 4.91 |

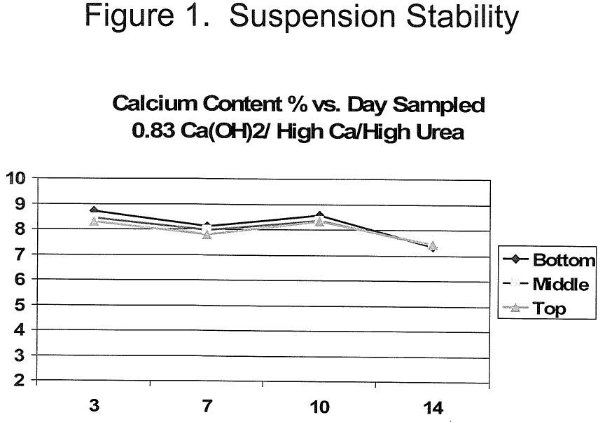

FIG. 1 graphs the positional stability data for one of these samples. All the data shows good positional stability for calcium concentration, which includes the water-soluble calcium carbonate component.

### CONCLUSION

It should be understood, of course, that two or more of the various preferred elements or steps of the invention are more advantageously practiced together to increase the efficiency and benefits that can be obtained from the invention.

Thus, the present invention is well adapted to carry out the objects and attain the ends and advantages mentioned above as well as those inherent therein. While preferred embodiments of the invention have been described for the purpose of this disclosure, changes in the construction and arrangement of parts and the performance of steps can be made by those skilled in the art, which changes are encompassed within the spirit of this invention as defined by the appended claims.

What is claimed is:

1. A method of preparing a liquid suspension, wherein the method comprises mixing, simultaneously or in separate steps, at least:
(a) a liquid source of digestible organic matter, wherein the liquid source of digestible organic matter comprises:
(i) water in a concentration of at least 25% by weight of the liquid source of digestible organic matter; and
(ii) digestible organic matter in a concentration of at least 5% by weight of the liquid source of digestible organic matter,
wherein the digestible organic matter comprises starch in a concentration of at least 10% by weight on a dry-matter basis, and
(b) at least a sufficient proportion of an alkali or alkali source to increase the stirred viscosity of the liquid source of digestible organic matter; and
(c) a water-insoluble material selected from the group consisting of a nutrient, a medicament, and any combination thereof in any proportion.

2. The method according to claim 1, wherein the digestible organic matter comprises crude fat in a concentration of at least 4% by weight on a dry-matter basis.

3. The method according to claim 1, wherein the water-insoluble material comprises carbonate selected from the group consisting of calcium carbonate, magnesium carbonate, and any combination thereof in any proportion.

4. The method according to claim 1, wherein the liquid source of digestible organic matter is a liquid that does not separate into separate phases when observed standing without shaking or stirring for at least one day at a temperature between 68° F. (20° C.) and 80° F. (27° C.) and at a pressure of about 1 atm (100 kPa).

5. The method according to claim 1, wherein the liquid source of digestible organic matter is a liquid having a stirred viscosity of less than 5,000 cP when measured at a temperature between 68° F. (20° C.) and 80° F. (27° C.) and at a pressure of about 1 atm (100 kPa).

6. The method according to claim 1, wherein the liquid source of digestible organic matter is produced by evaporating thin stillage removed from the mash in ethanol production to approximately 23%-50% by weight dry matter (50%-77% water) and having approximately 20%-30% crude protein on a dry-matter basis, 8%-25% crude fat on a dry-matter basis, 10%-60% NFE on a dry-matter basis, and 2%-5% crude fiber on a dry-matter basis.

7. The method according to claim 1, wherein the liquid source of digestible organic matter comprises corn condensed distillers solubles.

8. The method according to claim 1, wherein the alkali or alkali source is selected from the group consisting of calcium hydroxide, sodium hydroxide, potassium hydroxide, magnesium hydroxide, calcium oxide, and any combination thereof in any proportion.

9. The method according to claim 3, wherein the liquid source of digestible organic matter has a pH less than 5.8, and wherein the liquid source of digestible organic matter and the alkali or alkali source is mixed in proportion and under conditions to increase the pH of the liquid source of digestible organic matter to at least 5.8 prior to the addition of the carbonate.

10. The method according to claim 1, wherein the step or steps of mixing is or are performed such that the proportions of the liquid source of digestible organic matter, the alkali or alkali source, the water-insoluble material and the conditions of mixing are sufficient to obtain a resulting mixture as a liquid suspension of the water-insoluble material that does not separate into separate phases when observed standing without shaking or stirring for at least one day at a temperature between 68° F. (20° C.) and 80° F. (27° C.) and at a pressure of about 1 atm (100 kPa).

11. The method according to claim 1, further comprising the step, simultaneously or with any other step, mixing the liquid source of digestible organic matter with a water-soluble nutrient.

12. The method according to claim 11, wherein the water-soluble nutrient is selected from the group consisting of urea, sodium chloride, potassium chloride, and any combination thereof in any proportion.

13. The method according to claim 1, wherein the liquid source of digestible organic matter is mixed with at least the alkali or alkali source immediately after the liquid source of digestible matter is produced and is still at a temperature of at least 120° F. (49° C.).

14. The method according to claim 1, wherein the liquid source of digestible organic matter is at a temperature of at most 165° F. (74° C.) to avoid caramelization of sugars.

15. The method according to claim 1, wherein the steps of mixing are under conditions to maintain the pH of the liquid source of digestible organic matter and the mixtures thereof at a pH equal to or less than 8.5.

16. The method according to claim 1, wherein the resulting mixture is substantially free of any admixed non-digestible matter.

17. The method according to claim 1, wherein the resulting mixture is substantially free of admixed phosphate source.

18. The method according to claim 1, wherein the resulting mixture is substantially free of admixed sulfate source.

19. The method according to claim 1, wherein the resulting mixture has a dry-matter concentration in the range of 50%-70% by weight.

20. The method according to claim 19, wherein the resulting mixture has a stirred viscosity of between 600-4,000 cP when measured at a temperature in the range of 68° F. (20° C.)-80° F. (27° C.) and about 1 atmosphere (100 kPa) pressure.

21. The method according to claim 1, further comprising the step of: including the resulting mixture in a feed ration for an animal.

22. A method of preparing a liquid suspension comprising a carbonate, wherein the method comprises mixing, simultaneously or in separate steps, at least:
(a) a liquid source of digestible organic matter, wherein the liquid source of digestible organic matter comprises:
(i) water in a concentration of at least 25% by weight of the liquid source of digestible organic matter; and
(ii) digestible organic matter in a concentration of at least 5% by weight of the liquid source of digestible organic matter,
wherein the digestible organic matter comprises crude fat in a concentration of at least 4% by weight on a dry-matter basis,
wherein the liquid source of digestible organic matter has a stirred viscosity of at least 600 cP at a temperature between 68° F. (20° C.) and 80° F. (27° C.) and at a pressure of about 1 atm (100 kPa); and
wherein the liquid source of digestible organic matter has a pH of less than 5.8; and
(b) at least a sufficient proportion of a pH increasing agent to increase the pH of the liquid source of digestible organic matter to greater than or equal to 5.8; and
(c) a water-insoluble material, wherein the water-insoluble material comprises carbonate selected from the group consisting of calcium carbonate, magnesium carbonate, and any combination thereof in any proportion.

23. A method of preparing a liquid suspension, the method comprising the steps of:
(a) mixing:
(i) a liquid source of digestible organic matter, wherein the liquid source of digestible organic matter comprises condensed distillers solubles having starch in a concentration of at least 10% by weight on a dry-matter basis and crude fat in a concentration of at least 4% by weight on a dry-matter basis, wherein the liquid source of digestible organic matter has a stirred viscosity of at least 600 cP at a temperature between 68° F. (20° C.) and 80° F. (27° C.) and at a pressure of about 1 atm (100 kPa), and wherein the liquid source of digestible organic matter has a pH of less than 5.8;
(ii) at least a sufficient proportion of a pH increasing agent to increase the pH of the liquid source of digestible organic matter to greater than or equal to 5.8, wherein the pH increasing agent comprises an alkali or alkali source selected from the group consisting of calcium hydroxide, magnesium hydroxide, sodium hydroxide, potassium hydroxide, calcium oxide, magnesium oxide, and any combination thereof in any proportion; and
(b) thereafter mixing with the condensed distillers solubles a water-insoluble material, wherein the water-insoluble material comprises carbonate selected from the group consisting of calcium carbonate, magnesium carbonate, and any combination thereof in any proportion.

24. The method according to claim 23, further comprising the step of mixing a water-soluble nutrient selected from the group consisting of urea, sodium chloride, potassium chloride, calcium chloride, magnesium chloride, and any combination thereof in any proportion with the corn condensed distillers solubles.

25. The method according to claim 24, wherein the resulting mixture has a dry-matter concentration in the range of 50%-70% by weight and a stirred viscosity of between 600-4,000 cP when measured at a temperature in the range of 68° F. (20° C.)-80° F. (27° C.) and about 1 atmosphere (100 kPa) pressure.

26. The method according to claim 23, wherein the steps of mixing are performed immediately after the condensed distillers solubles is produced and is still at a temperature of at least 120° F. (49° C.).

27. A method of preparing a liquid suspension, the method comprises the step of mixing at least:
(a) a liquid source of digestible organic matter, wherein the liquid source of digestible organic matter comprises:
(i) water in a concentration of at least 25% by weight of the liquid source of digestible organic matter; and
(ii) digestible organic matter in a concentration of at least 5% by weight of the liquid source of digestible organic matter, and
(iii) starch in a concentration of at least 10% by weight on a dry-matter basis, and
wherein the liquid source of digestible organic matter has a stirred viscosity of at least 600 cP at a temperature between 68° F. (20° C.) and 80° F. (27° C.) and at a pressure of about 1 atm (100 kPa);
(b) a water-soluble nutrient; and
(c) a water-insoluble material, wherein the water-insoluble material comprises carbonate selected from the group consisting of calcium carbonate, magnesium carbonate, and any combination thereof in any proportion,
wherein the resulting mixture has a dry-matter concentration in the range of 50%-70% by weight and a stirred viscosity of between 600-4,000 cP when measured at a temperature in the range of 68° F. (20° C.)-80° F. (27° C.) and about 1 atmosphere (100 kPa) pressure.

28. The method according to claim 27, wherein the liquid source of digestible organic matter consists essentially of condensed distillers solubles.

29. The method according to claim 28, wherein the digestible organic matter in the resulting mixture is derived substantially entirely from the condensed distillers solubles.

30. The method according to claim 27, wherein the water-soluble nutrient is selected from the group consisting of urea, sodium chloride, potassium chloride, calcium chloride, magnesium chloride, and any combination thereof in any proportion.

31. The method according to claim 27, further comprising an alkali or alkali source.

32. The method according to claim 31, wherein the alkali or alkali source is in a sufficient concentration to increase the stirred viscosity of the liquid source of digestible organic matter to compensate for the reduction of the stirred viscosity of the liquid source of digestible organic matter caused by the water-soluble nutrient.

33. The method according to claim 27, wherein the step of mixing is performed immediately after the condensed distillers solubles is produced and is still at a temperature of at least 120° F. (49° C.).
